(19) United States
(12) Patent Application Publication
(10) Pub. No.: US 2008/0159290 A1
(43) Pub. Date: Jul. 3, 2008

(54) Method of Preventing Transport Leaks in Hybrid Switching Networks

(75) Inventors: Robert Sultan, Somers, NY (US); Linda Dunbar, Plano, TX (US); Lucy Yong, Tulsa, OK (US)

Correspondence Address: CONLEY ROSE, P.C., 5601 GRANITE PARKWAY, SUITE 750, PLANO, TX, 75024, US

(73) Assignee: FUTUREWEI TECHNOLOGIES, INC., Plano, TX (US)

(21) Appl. No.: 11/691,556

(22) Filed: Mar. 27, 2007

Related U.S. Application Data
(60) Provisional application No. 60/882,404, filed on Dec. 28, 2006.

(51) Int. Cl. H04L 12/56

(52) U.S. Cl. 370/392; 370/401; 370/465

(57) ABSTRACT

A communications network component comprising a processor configured to implement a method comprising receiving a first data structure comprising a first VID and a first forwarding type, determining whether the first data structure supersedes a second data structure comprising a second VID and a second forwarding type, and replacing the second data structure with the first data structure if the first data structure supersedes the second data structure is disclosed. Also disclosed is a method for maintaining the consistency of a table in a plurality of nodes, comprising receiving a registration of a table comprising a VID and a forwarding type, and distributing the table to a plurality of nodes associated with the registration.

### CROSS-REFERENCE TO RELATED APPLICATIONS

The present application claims priority to U.S. Provisional Patent Application Ser. No. 60/882,404, filed Dec. 28, 2006 by Sultan et al., and entitled “Method of Preventing Transport Leaks in Hybrid Switching Networks,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Modern communication and data networks are comprised of nodes that transport data through the network. The nodes may include routers, switches, and/or bridges that transport the individual data frames or packets through the network. A hybrid switching network is one in which the network is partitioned into virtual local area networks (VLANs) using VLAN identifiers (VIDs) or by some other criterion, and deploys one of multiple transport methodologies, depending on the VID with which it is associated.

One of the problems that occur in hybrid switching networks is the misprovisioning of a node. When this occurs, copies of frames from one transport connection leak into other transport connections that share the same VID. The result is that multiple copies of the frame are delivered to the destination and/or the effective capacity of the transport connections is less than the committed capacity. Consequently, a need exists for methods of detecting or preventing frame leakage in a hybrid switching network when misprovisioning occurs.

### SUMMARY

In one embodiment, the disclosure includes a communications network component comprising a processor configured to implement a method comprising receiving a first data structure comprising a first VID and a first forwarding type, determining whether the first data structure supersedes a second data structure comprising a second VID and a second forwarding type, and replacing the second data structure with the first data structure if the first data structure supersedes the second data structure.

In another embodiment, the disclosure includes a method for maintaining the consistency of a table in a plurality of nodes, comprising receiving a registration of a table comprising a VID and a forwarding type, and distributing the table to a plurality of nodes associated with the registration.

In a third embodiment, the disclosure includes a communications network component comprising a processor configured to implement a method comprising determining whether a data structure needs to be sent to a node, and promoting the sending of the data structure to the node if the data structure needs to be sent to the node, wherein the data structure comprises a plurality of VIDs and a plurality of forwarding types associated with the VIDs.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1A is a framework of one embodiment of a hybrid communications network.

FIG. 1B is a framework of one embodiment of hybrid communications network.

FIG. 1C is a framework of one embodiment of a hybrid communications network.

FIG. 2 is a framework of another embodiment of an Ethernet frame.

FIG. 3 is a flowchart of one embodiment of a Frame Modification Method.

FIG. 4 is an illustration of one embodiment of a VID Table.

FIG. 5 is a flowchart of one embodiment of a Frame Processing Method.

FIG. 6 is a flowchart of one embodiment of a Leakage Detection Method.

FIG. 7 is a flowchart of one embodiment of a VID Table Consistency Verification Method.

FIG. 8 is a flowchart of another embodiment of the VID Table Consistency Verification Method.

FIG. 9 is a flowchart of another embodiment of the VID Table Consistency Verification Method.

FIG. 10 is a framework of one embodiment of a general-purpose network component.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

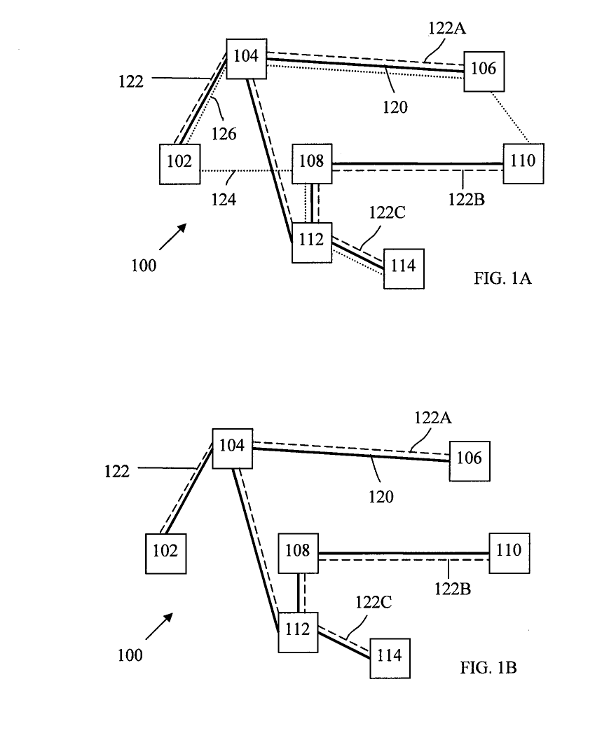

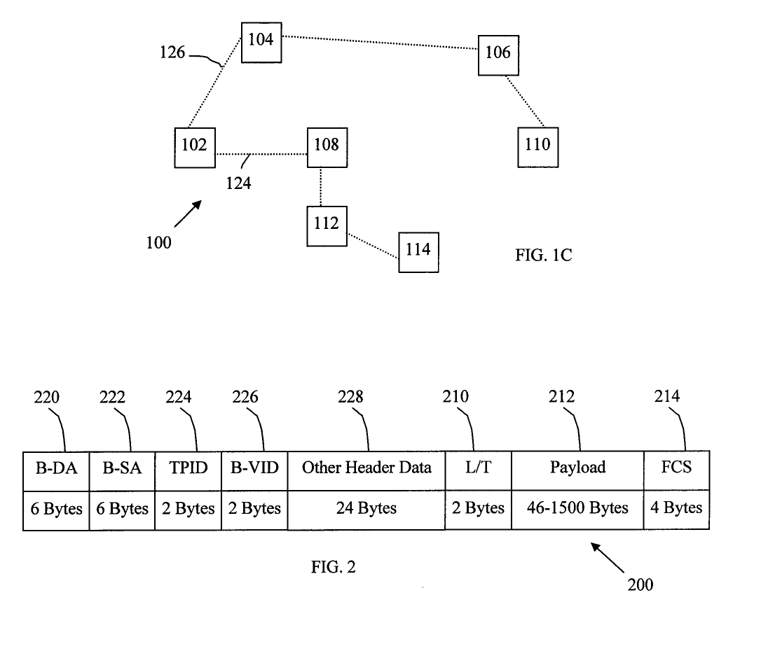

FIGS. 1A, 1B, and 1C illustrate one embodiment of a hybrid communications network 100. Specifically, FIG. 1A illustrates the integrated network configuration, while FIG. 1B illustrates the bridged (connectionless) portion of the network and FIG. 1C illustrates the switched (connection-oriented) portion of the network. The network 100 comprises a plurality of nodes 102, 104, 106, 108, 110, 112, 114 (102-114) that are at least partially interconnected together using a plurality of links (not shown). The flow of traffic within the bridged portion of the network 100 may be improved by the inclusion of at least one VLAN 122 and a spanning tree 120. Similarly, the flow of traffic within the switched portion of the network 100 may be improved by the inclusion of a plurality of connections 124, 126. These components are described in further detail below. Both the switched portion and the bridged portion of the network 100 use a VID to associate the frames with either the VLAN 122 or connections 124, 126. As such, the network 100 may also include a management or control plane (not shown) that may provision the nodes 102-114 such that the VIDs are associated with either the switched portion or the bridged portion of the network 100.

The network 100 may be any type of network 100 that transports frames from a source node to a destination node. Specifically, the network 100 may be a hybrid switching network that transports both bridged and switched frames from the source node to the destination node using the VLAN 122 or the connection 124, 126. The network 100 may be a backbone network, a provider network, or an access network running any one of a variety of protocols. Ethernet is a suitable protocol, and the methods described herein may be adapted for other protocols, including Internet Protocol (IP) and Asynchronous Transfer Mode (ATM), among others. In a specific embodiment, the network 100 is a hybrid bridged and switched Ethernet backbone network.

The nodes 102-114 may be any device that transports frames through the network 100. For example, the nodes 102-114 may include bridges, switches, routers, or various combinations of such devices. Such devices typically contain a plurality of ingress ports for receiving frames from other nodes 102-114, logic circuitry to determine which nodes 102-114 to send the frames to, and a plurality of egress ports for transmitting frames to the other nodes 102-114. In an embodiment, the nodes 102-114 make the determinations needed to transport the frames through the network at Open System Interconnection (OSI) layer two. The nodes 102-114 may include Backbone Edge Bridges (BEBs), Backbone Core Bridges (BCBs), Provider Edge Bridges (PEBs), S-VLAN Bridges as defined by IEEE 802.1ad, C-VLAN Bridges as defined by IEEE 802.1Q, or various combinations of such devices. Edge bridges may be connected to nodes within two different networks, such as a provider network and a backbone network or a customer network and a provider network, while core bridges are typically connected to other nodes within the same network. For example, if the network 100 is a backbone network, then the nodes 102, 110, 114 may be BEBs, while the nodes 104, 106, 108, 112 may be BCBs.

The nodes 102-114 within the network 100 may communicate with each other via a plurality of links. The links may be electrical, optical, wireless, or any other type of communications links. While it is contemplated that every node 102-114 within the network 100 may be connected to every other node 102-114 within the network 100, it is more common to have each of the nodes 102-114 connected to only some of the other nodes 102-114 within the network 100. Such a configuration reduces the number of the links between the various nodes 102-114. In the case where the nodes 102-114 are geographically separated from each other, the reduced number of links significantly decreases the complexity and the cost of the network 100.

The nodes 102-114 may send frames to other nodes 102-114 using a spanning tree 120. Briefly, the spanning tree 120 is a protocol that resides in the network 100 that allows frames to be forwarded through the network 100 without taking circular or looping paths. Specifically, the spanning tree 120 describes a unique path from a node in the network 100 to another node in the network 100. The uniqueness of the path prevents loops within the network 100. The spanning tree 120 is associated with the network 100, and there may be multiple spanning trees 120 per network 100. In steady state, a spanning tree 120 should include all nodes in the network 100. Examples of suitable spanning tree protocols for creation of a spanning tree 120 include Spanning Tree Protocol (STP), Rapid Spanning Tree Protocol (RSTP), and Multiple Spanning Tree Protocol (MSTP).

The bridged portion of the network 100 may include at least one VLAN 122. The VLAN 122 may be a contiguous subset of bridges and links associated with a particular spanning tree. The VLAN 122 indicates the desired path for data to follow to get to a particular node. The VLAN 122 may have a plurality of branches 122A, 122B, 122C such that data can be transported to a node from any other node 102-114 associated with the VLAN 122. FIGS. 1A and 1B illustrate one example of a branched VLAN 122 associated with node 102. Alternatively, the VLAN 122 could be configured with a single branch, similar to a connection 124, 126. If desired, the network 100 may contain a plurality of VLANs 122 for each node.

VIDs are used to associate the frames with the VLANs 122 in the bridged portion of the network 100. Generally, a VLAN is a portion of a spanning tree, thus the VLAN is a tree. The VLAN may have branches, and all of the branches of the VLAN have the same VID. Each VLAN is associated with only one VID; however, a VID may be associated with a plurality of distinct VLANs when the VLANs do not overlap.

The VLANs 122 may be used to transport the frames through the bridged portion of the network 100. Such a process begins by associating the frames with the VLAN 122 by adding the VID to the frames. The VID may also be added to a forwarding database in each of the nodes 102-114, if desired. When a node 102-114 receives a frame with a VLAN 122, the node 102-114 accesses the forwarding database and uses the frame's destination address and VID to determine the egress port on which the frame is to be forwarded. If the forwarding database lacks an entry for the destination address and VID, then the node 102-114 floods the frame on all of its egress ports associated with the spanning tree 120, except the port on which the frame was received. Thus, the frames can be forwarded to the destination node from any node 102-114 within the network 100.

The node 102-114 can “learn” the source address by adding the source address, the VID, and the port on which the frame was received to the forwarding database. Thus, when the node 102-114 receives a frame with a destination address identical to the previous frame's source address, the node 102-114 knows where to send the frame.

The switched portion of the network 100 may include at least one connection 124, 126. The connections 124, 126 may be point-to-point logical paths between two BEBs 102, 110, 114 at the edge of the network. Unlike the VLAN 122, the connections 124, 126 are singular point-to-point connections in that they do not contain any branches. In specific embodiments, the connection 124, 126 may be an Ethernet Virtual Connection (EVC) as defined by the Metropolitan Ethernet Forum (MEF) or an Ethernet Switched Path (ESP).

Similar to the bridged portion of the network 100, the switched portion of the network may use VIDs to associate the frames with the connections 124, 126. Each connection 124, 126 may be uniquely identified by its destination address, source address, and VID. More specifically, no two connections 124, 126 in a single network 100 may share a common destination address, source address, and VID combination.

Similar to the bridged portion, the switched portion of the network 100 transports the frames through the network 100 by first associating the frames with the connection 124, 126. Specifically, the VID is added to the frames and to the forwarding database of each node 102-114 associated with the connection 124, 126. When a node 102-114 receives a frame associated with a connection 124, 126, the node 102-114 accesses the forwarding database and uses the frame's destination address and VID to determine the egress port associated with the connection 124, 126. The node 102-114 then forwards the frame to the specific egress port associated with the frame's destination address and VID. Because the forwarding database is provisioned at each node 102-114, the flooding, learning, and spanning tree portions of the bridged portion of the network 100 are not used in the switched portion of the network 100. As such, if a node 102-114 encounters a frame that is associated with a connection 124, 126 that is not in the forwarding database, the node 102-114 drops the frame. Thus, frames traveling along the connection 124, 126 may be transported through the network 100 with minimal processing at each node 102-114.

The problems associated with such a network configuration become apparent when a node 102-114 is misprovisioned. As an example, assume that the VLAN 122 is associated with VID 5 and that the connections 124, 126 are associated with VID 10. Thus, frames associated with VID 5 should be bridged, while frames associated with VID 10 should be switched. Further, assume that node 112 has been misprovisioned in that it has erroneously associated VID 10 with bridged behavior instead of switched behavior and that no forwarding entry has been provisioned. It would be normal not to provision a forwarding entry when the associated VID is provisioned for bridging. When node 112 receives a frame associated with VID 10 from node 114, node 112 should forward the frame to node 108. However, because node 112 associates VID 10 with bridged behavior instead of switched behavior, the node 112 processes the frame as a bridged frame. Additionally, because no forwarding entry is provisioned, the node 112 does not find the frame's destination address in its forwarding database, the node 112 floods the frame to nodes 104 and 108 in accordance with the spanning tree 120. In such a case, node 104 sends the frame to node 102 using the connection 126, and node 108 forwards the frame to node 102.

Misprovisioned nodes may be created when a provider upgrades a node 102-114 from bridged behavior to hybrid (bridged and switched) behavior. Specifically, during the upgrade the provider may continue to use the node primarily for bridging, and gradually declare specific VIDs associated with switching. Thus, it is likely that a VID assigned to switching would have previously been assigned to bridging. The failure to update the VID in the forwarding database of a single node 102-114 along the connection 124, 126 would cause the described misprovisioning. As a result, the misprovisioned node decreases the quality of service for the connection 126 by allowing frames from the connection 124 to leak into connection 126. The misprovisioned node can also cause duplicate frames to reach the destination node 102, such as when node 112 floods the frame to nodes 104 and 108. Finally, the existence of the misprovisioned nodes is usually difficult to determine because the frames ultimately reach their destination, and thus no alarms are raised. Consequently, a need exists for a method for detecting and/or preventing misprovisioned nodes in a hybrid switching network.

Disclosed herein are methods for detecting and/or preventing misprovisioned nodes in a hybrid switching network. Specifically, the frames may be associated with a particular forwarding type, which may be bridged or switched. In addition, a VID Table that indicates the forwarding behavior associated with each VID is provided at each node associated with the connections 124, 126. Leaked frames and thus the existence of a misprovisioned node may be detected by comparing the frames' forwarding type with the VID Table. Frames with inconsistent forwarding types are dropped, so that leaked frames do not compromise the bandwidth allocated to other connections 124, 126. Furthermore, several methods are provided for maintaining correctly provisioned nodes within the network 100.

A frame may be any unit of data that is transported from a source to a destination. FIG. 2 is an example of a frame 200 that has been modified to include the forwarding type. Specifically, FIG. 2 illustrates an IEEE 802.1ah Ethernet frame that may comprise the following fields: a destination address 220, a source address 222, a tag protocol identifier (TPID) 224, a backbone VID (B-VID) 226, other header data 228, a length/type 210, a payload 212, and a frame check sequence 214. Briefly, the destination address 220 may indicate the destination node, and the backbone source address 222 may indicate the backbone source node. Persons of ordinary skill in the art will appreciate that the destination address and source address may refer to Media Access Control (MAC) addresses, including Backbone MAC (B-MAC) addresses. The other header data 228 may include various other header information known to persons of ordinary skill in the art, the length/type 210 indicates the length or type of payload, the payload 212 is the data that the frame is carrying, and the frame check sequence 214 is used to verify the integrity of the frame. The frame 200 may also include a preamble that identifies the start of the frame.

The TPID 224 may be used to identify the forwarding type associated with the frame, and the backbone VID 226 may be used to identify the VID associated with the frame. For example, the value “88A8” in the TPID 224 field may indicate that the VID identified in the B-VID 226 field identifies a bridged VID. Similarly, other values such as “8100” or any other assigned value may indicate that the VID identified in the B-VID 226 field identifies a switched VID. If other forwarding types exist within the network, then the TPID 224 and the VID 226 fields may be used to associate the frames with those forwarding types. Persons of ordinary skill in the art are aware of other entries that can be used to associate one of the TPID 224 fields with the various forwarding types.

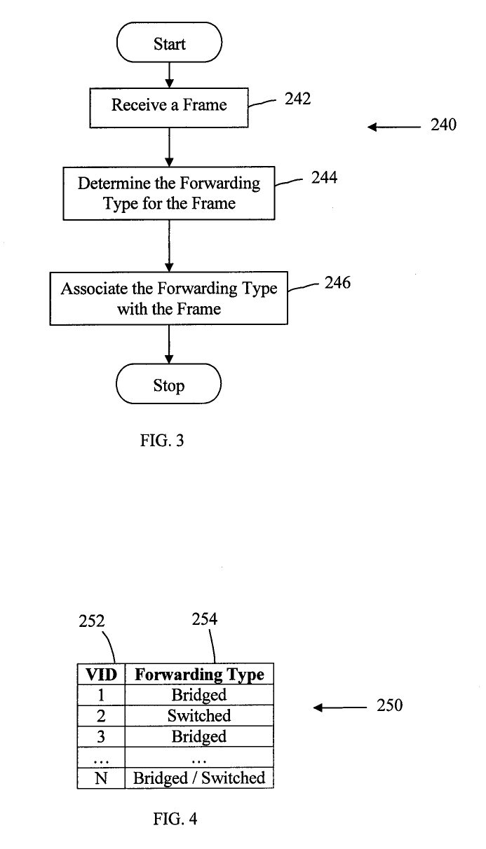

FIG. 3 illustrates one embodiment of a Frame Modification Method 240. The Frame Modification Method 240 associates the frames with a particular forwarding type, such as bridged or switched. The Frame Modification Method 240 may optionally determine the frame's VID and add the VID to the frame. The Frame Modification Method 240 is generally implemented at the ingress node of the network, such as a PEB or BEB, but may also be implemented at any other node within the network. Each of the blocks of the Frame Modification Method 240 is described in further detail below.

The Frame Modification Method 240 may begin when a node receives a frame at 242. The frame is generally received from another network, such as a customer network or provider network. After receiving the frame at 242, the Frame Modification Method 240 may determine the frame's forwarding type at 244. The forwarding type associates the frame with switched behavior, bridged behavior, or any other forwarding type known to persons of ordinary skill in the art. The frame's forwarding type may be found in a VID Table 250, which is described in detail below. Alternatively, the frame's forwarding type may be determined by various methods known to persons of ordinary skill in the art.

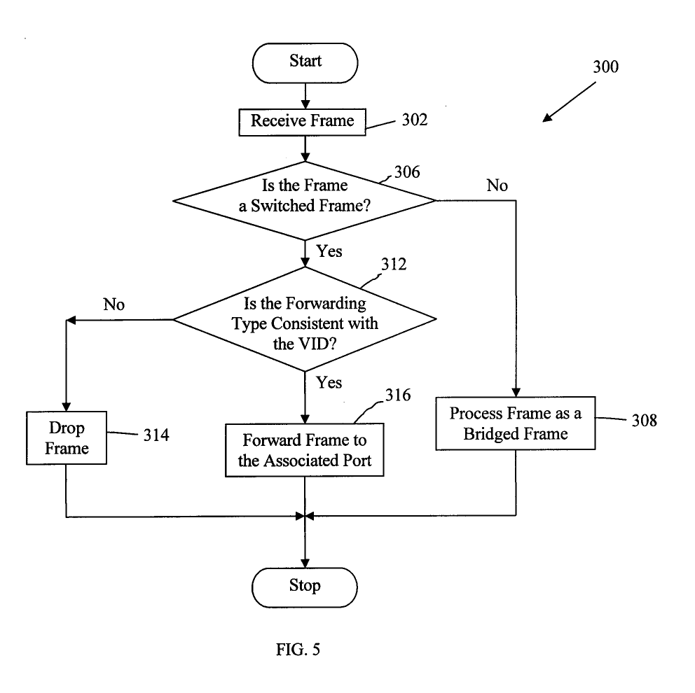

After identifying the frame's forwarding type, the Frame Modification Method 240 may associate the forwarding type with the frame at 246. In an embodiment, the frame's forwarding type is associated with the frame by adding the forwarding type to the frame. The VID is also added to the frame. Although the forwarding type may be added to any portion of the frame, it may be advantageous to identify the forwarding type by the value of the TPID field as described above. Such an embodiment is advantageous because it does not change the structure or the other fields in the frame, and thus does not render the frame unrecognizable to networks and/or devices that do not implement the processes described herein. The Frame Modification Method 240 works with the Frame Processing Method shown in FIG. 5 to ensure that the type carried in the frame is consistent with the type configured for the VID at each intermediate node.

FIG. 4 illustrates one example of a VID Table 250 that is used by the Frame Modification Method 240 discussed above and the Frame Processing Method 300 discuss below. The VID Table 250 comprises at least two columns: a VID column 252 and a forwarding type column 254. The VID column 252 lists the various VIDs associated with the network. The forwarding type column 254 lists the forwarding type associated with each VID. The VID Table 250 may also contain columns for the destination address and source address, if desired. Thus, the rows within the VID Table 250 characterize the forwarding type associated with each VID in the network. In an embodiment, the VID Table 250 at each node may only contain the entries for the VIDs that the node is associated with. As explained in detail below, the VID Table 250 may be accessible by or distributed to every node within the network using various methods and/or protocols. Moreover, the consistency of the VID Table 250 throughout the nodes can be maintained and verified using the methods disclosed herein.

FIG. 5 illustrates one embodiment of a Frame Processing Method 300. The Frame Processing Method 300 works with the Frame Modification Method 240 described above to ensure that the type carried in the frame is consistent with the type configured for the VID at each intermediate node. Specifically, the Frame Processing Method 300 drops the frames when the frames' forwarding type is inconsistent with the forwarding type in the VID Table. The Frame Processing Method 300 is generally implemented at the nodes associated with a connection, but may also be implemented at any other node within the network.

The Frame Processing Method 300 may begin when a node receives a frame at 302. The frame is generally received from another node in the same network, such as a backbone network. The Frame Processing Method 300 then analyzes the frame to determine whether the frame is a switched frame at 306. As discussed above, the frame's forwarding type defines whether the frames are transported across the network using a bridged behavior or a switched behavior. The frame's forwarding type may be determined by accessing the forwarding type embedding in the frame. If the frame is a switched frame, then the Frame Processing Method 300 proceeds to block 310. If the frame is not a switched frame, then the Frame Processing Method 300 proceeds to block 308.

The Frame Processing Method 300 processes the frame as a bridged frame at 308. Specifically, the Frame Processing Method 300 may access a forwarding database to determine the egress node associated with the frame, and may forward the frame onto the appropriate egress port. Alternatively, the Frame Processing Method 300 may flood the frame onto a plurality of ports in accordance with the process described above. In addition, the Frame Processing Method 300 may also add the frame's source address and ingress port to the forwarding database, if desired. The Frame Processing Method 300 then ends until another frame is received.

The Frame Processing Method 300 then determines whether the frame's forwarding type is consistent with the VID at 312. The frame's forwarding type is consistent with the VID if the frame's forwarding type is the same as the forwarding type associated with the VID. As part of the consistency determination, the Frame Processing Method 300 may compare the frame's forwarding type to the forwarding type listed in the VID Table for the VID specified by the frame. Alternatively, the node may be aware of the forwarding types that the node is associated with and can determine whether the frame's forwarding type is associated with the node. If the frame's forwarding type is different than the forwarding type listed in the VID Table or the frame's forwarding type is not associated with the node, then the frame's forwarding type is inconsistent with the VID, and the Frame Processing Method 300 proceeds to 314. If the frame's forwarding type is the same as is listed in the VID Table or the frame's forwarding type is associated with the node, then the frame's forwarding type is consistent with the node, and the Frame Processing Method 300 proceeds to block 316.

The Frame Processing Method 300 may drop the frame at 314. In one embodiment, when the Frame Processing Method 300 drops the frame, the Frame Processing Method 300 may simply delete the frame and proceed to the next frame. However, in alternative embodiments, the Frame Processing Method 300 may be configured with functionality that is more sophisticated. Specifically, when the frame's determinations at blocks 310 or 312 are negative, there is a high likelihood that there is an incorrectly provisioned node within the network, for example an incorrectly provisioned VID Table in an upstream node. While dropping the frame prevents the leaked frame from affecting other connections, it does not correct the provisioning error. Thus, it is contemplated that the Frame Processing Method 300 may also raise an alarm to indicate that there is an error within the network. The Frame Processing Method 300 then ends until another frame is received.

At block 316, the Frame Processing Method 300 forwards the frame onto the appropriate port. Specifically, the Frame Processing Method 300 determines the egress port associated with the frame's destination address and VID, and forwards the frame onto the port specified in the forwarding database. After the frame is forwarded to the appropriate egress port, the Frame Processing Method 300 ends until another frame is received.

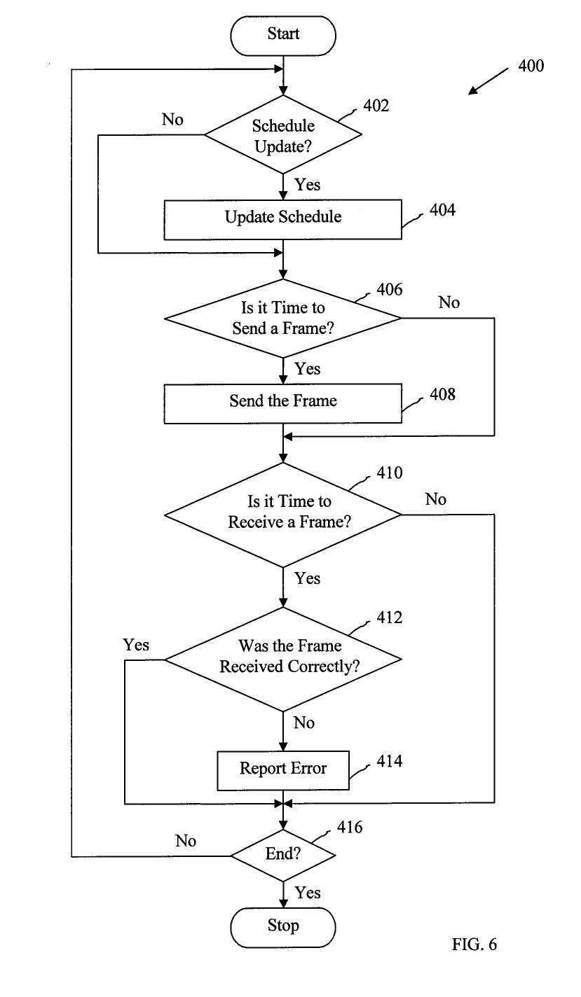

FIG. 6 is a flowchart of one embodiment of a Leakage Detection Method 400. While the Frame Processing Method 300 can be used to indirectly determine whether there is a loss of connectivity within the network, for example when the frames are lost along a particular connection, the Leakage Detection Method 400 provides a direct method for determining the location of a connectivity loss. Specifically, the Leakage Detection Method 400 sends frames, such as operations, administration, and maintenance (OAM) frames, to specific nodes on a predetermined schedule. When implementing the Leakage Detection Method 400, each node may be equipped with or have access to a schedule, such as a table or other data structure that indicates which nodes to send the OAM frames to, when the OAM frames should be sent, which nodes to expect the OAM frames from, and when to expect the OAM frames. The Leakage Detection Method 400 may be run sequentially or concurrently with any of the other processes described herein. Persons of ordinary skill in the art will be aware of how to modify the Leakage Detection Method 400 such that it may be implemented or controlled by a management or control plane, if desired.

The Leakage Detection Method 400 may start when implemented by a user or upon initialization of a node. After starting, the Leakage Detection Method 400 determines whether there is a schedule update at 402. There may be a schedule update when there is a change to the schedule of when frames are sent or received. In addition, there may also be a schedule update when there is a change in the other nodes that the present node sends frames to or receives frames from. If the Leakage Detection Method 400 determines there is not a schedule update, then the Leakage Detection Method 400 proceeds to block 406. If the Leakage Detection Method 400 determines there is a schedule update, then the Leakage Detection Method 400 proceeds to block 404.

The Leakage Detection Method 400 then updates the schedule at 404. The Leakage Detection Method 400 may update the schedule by performing at least one of the following tasks: receiving a schedule update from another node, recording the schedule update in a schedule, sending the schedule update to any affected nodes, or notifying an administrator or other party of the change in the schedule. After the schedule has been updated, the Leakage Detection Method 400 proceeds to block 406.

The Leakage Detection Method 400 may then determine whether it is time to send a frame at 406. It may be time to send a frame when the current time matches the time to send a frame that is listed in the schedule. If the Leakage Detection Method 400 determines that it is time to send a frame, then the Leakage Detection Method 400 proceeds to block 408. If the Leakage Detection Method 400 determines that it is not time to send a frame, then the Leakage Detection Method 400 proceeds to block 410.

The Leakage Detection Method 400 may then send the frame at 408. Although the Leakage Detection Method 400 may send any type of frame at 408, the disruptions to the overall network may be minimized by sending an OAM frame or a connectivity check message. Specifically, the OAM frame or connectivity check message does not significantly disrupt the traffic flow between two nodes and consumes a minimal amount of bandwidth. Regardless of the frame type, the frames may contain a VID and/or forwarding type so that the frames or messages will follow the same path as the normal frames. The Leakage Detection Method 400 may then proceed to block 410.

The Leakage Detection Method 400 may then determine whether it is time to receive a frame at 410. It will be time to receive a frame when the current time matches the time to receive a frame that is listed in the schedule. If the Leakage Detection Method 400 determines that it is time to receive a frame, then the Leakage Detection Method 400 proceeds to block 412. If the Leakage Detection Method 400 determines that it is not time to receive a frame, then the Leakage Detection Method 400 proceeds to block 416.

The Leakage Detection Method 400 may then determine whether the frame was received correctly at 412. A frame is not received correctly if the frame is not received, received before the predetermined deviation before the reception time, received after the predetermined deviation time after the reception time, or is received more than once. A frame is received correctly if the frame is received within a predetermined deviation time, e.g. ±ten milliseconds, from the reception time listed in the schedule. Persons of ordinary skill in the art will know how and to what extent to configure a node with the predetermined deviation time from the reception time listed in the schedule. If the Leakage Detection Method 400 determines the frame was received correctly, then the Leakage Detection Method 400 proceeds to block 416. If the Leakage Detection Method 400 determines the frame was not received correctly, then the Leakage Detection Method 400 proceeds to block 414.

The Leakage Detection Method 400 may then report an error at 414. Errors may be reported using any one of several methods known to persons of ordinary skill in the art. For example, the node may send a message, such as an OAM frame or an error message, to an administrator or other central location. The message may contain additional information, such as the time of the connectivity loss, the location of the connectivity loss, recommendations for further action, or the actions taken by the node to reroute the affected traffic. The Leakage Detection Method 400 may also raise an alarm that indicates a loss of connectivity. The administrator or an automated process can then examine the network, determine the extent of the connectivity loss, and take corrective measures. The Leakage Detection Method 400 may then proceed to block 416.

The Leakage Detection Method 400 may then determine whether the Leakage Detection Method 400 should end at 416. The Leakage Detection Method 400 should end when instructed to do so, for example, when the administrator closes the Leakage Detection Method 400, or when the node is being taken offline. If the Leakage Detection Method 400 determines that it should not end, then the Leakage Detection Method 400 returns to block 402. If the Leakage Detection Method 400 determines that it should end, then the Leakage Detection Method 400 ends.

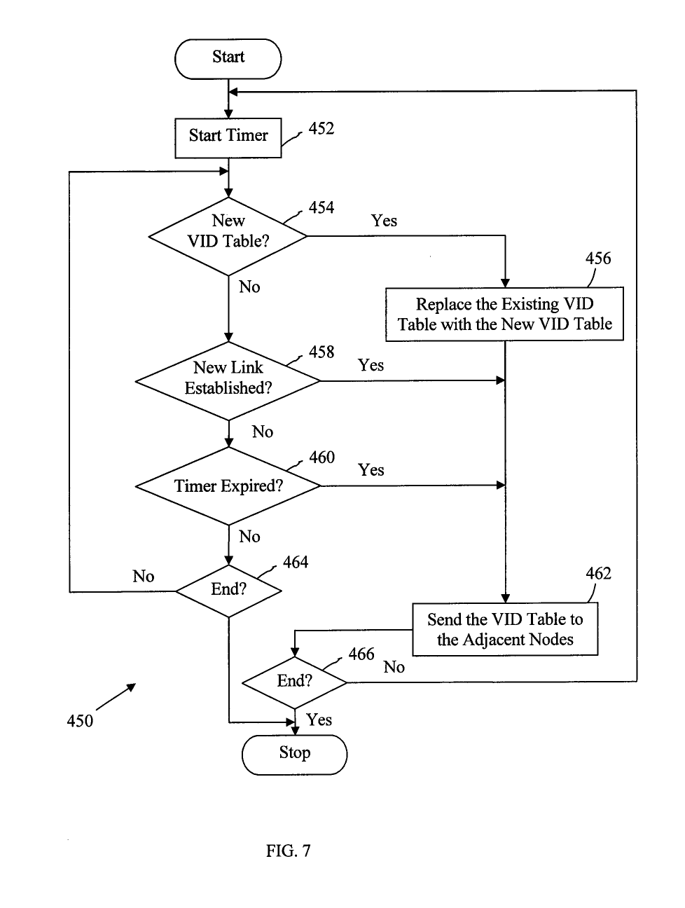

FIG. 7 is a flowchart of one embodiment of the VID Table Consistency Verification Method 450. The VID Table Consistency Verification Method 450 reduces the likelihood of an incorrectly provisioned node within the network by verifying the consistency of the VID Tables between nodes. The VID Table Consistency Verification Method 450 may be implemented at any node within the network, or at a central location within the network. Persons of ordinary skill in the art will be aware of how to modify the VID Table Consistency Verification Method 450 such that it may be implemented or controlled by a management or control plane, if desired.

The VID Table Consistency Verification Method 450 may then determine whether there is a new VID Table at 454. There may be a new VID Table if the node has updated its own VID Table or the node has received a new VID Table. If the VID Table Consistency Verification Method 450 determines there is a new VID Table, then the VID Table Consistency Verification Method 450 proceeds to block 456. If the VID Table Consistency Verification Method 450 determines there is not a new VID Table, then the VID Table Consistency Verification Method 450 proceeds to block 458.

The VID Table Consistency Verification Method 450 may then replace the existing VID Table with the new VID Table at 456. Specifically, the VID Table Consistency Verification Method 450 may overwrite the contents of the existing VID Table with the contents of the new VID Table. Alternatively, the VID Table Consistency Verification Method 450 may overwrite part of the contents of the existing VID Table with a corresponding part of the contents of the new VID Table. The VID Table Consistency Verification Method 450 then proceeds to block 462.

At block 458, the VID Table Consistency Verification Method 450 may then determine whether a new link has been established. A new link may have been established when the node detects a connection to a new node or the node receives a notification that a new link has been established. If the VID Table Consistency Verification Method 450 determines a new link has been established, then the VID Table Consistency Verification Method 450 proceeds to block 462. If the VID Table Consistency Verification Method 450 determines a new link has not been established, then the VID Table Consistency Verification Method 450 proceeds to block 460.

The VID Table Consistency Verification Method 450 may then determine whether the timer has expired at block 460. The timer may have expired if the node detects that the timer initiated at block 452 has expired or the node receives a notification that the timer has expired. If the VID Table Consistency Verification Method 450 determines the timer has expired, then the VID Table Consistency Verification Method 450 proceeds to block 462. If the VID Table Consistency Verification Method 450 determines the timer has not expired, then the VID Table Consistency Verification Method 450 proceeds to block 464.

The VID Table Consistency Verification Method 450 may then forward the VID Table to the adjacent nodes at block 462. The VID Table Consistency Verification Method 450 may forward the VID Table to the adjacent nodes by flooding the VID Table onto all of the node's ports. In an alternative embodiment, the VID Table Consistency Verification Method 450 may flood the VID Table onto less than all of the ports if the VID Table Consistency Verification Method 450 can exclude at least one of the ports for some reason, for example because the new VID Table was received on a particular port. The VID Table Consistency Verification Method 450 then proceeds to block 466.

The VID Table Consistency Verification Method 450 may then determine whether the VID Table Consistency Verification Method 450 should end at 464 and 466. The VID Table Consistency Verification Method 450 should end when instructed to do so, for example, when the administrator closes the VID Table Consistency Verification Method 450, or when the node is being taken offline. If at 464 the VID Table Consistency Verification Method 450 determines the VID Table Consistency Verification Method 450 should not end, then the VID Table Consistency Verification Method 450 returns to block 454. If at 464 the VID Table Consistency Verification Method 450 determines the VID Table Consistency Verification Method 450 should end, then the VID Table Consistency Verification Method 450 ends. If at 466 the VID Table Consistency Verification Method 450 determines the VID Table Consistency Verification Method 450 should not end, then the VID Table Consistency Verification Method 450 returns to block 452. If at 466 the VID Table Consistency Verification Method 450 determines the VID Table Consistency Verification Method 450 should end, then the VID Table Consistency Verification Method 450 ends.

The VID Table Consistency Verification Method 450 may be implemented using a network management system or application, such as the IEEE 802.1ak multiple registration protocol (MRP). For example, a MRP Table Registration Protocol (MTRP) can be created where nodes may register, join, leave, or deregister from the table registration process. Specifically, a participant in the protocol, such as a node, can register a table by the table name and the table contents. Other participants may join a registered table by specifying the associated table name. The participants may optionally add entries to or delete entries from the registered table. The operation of this protocol is as follows:
Register (Table Name, Table Contents): Reject request if table of this name already exists.
Join (Table Name, VID Table Contents): Reject request if no table with this table name or if table contents specified on join differs from that specified on register.
Leave (Table Name): Reject request if no table with this name.
Deregister (Table Name): Reject request if no table of this table name has been registered or if participants are currently registered to this table name.

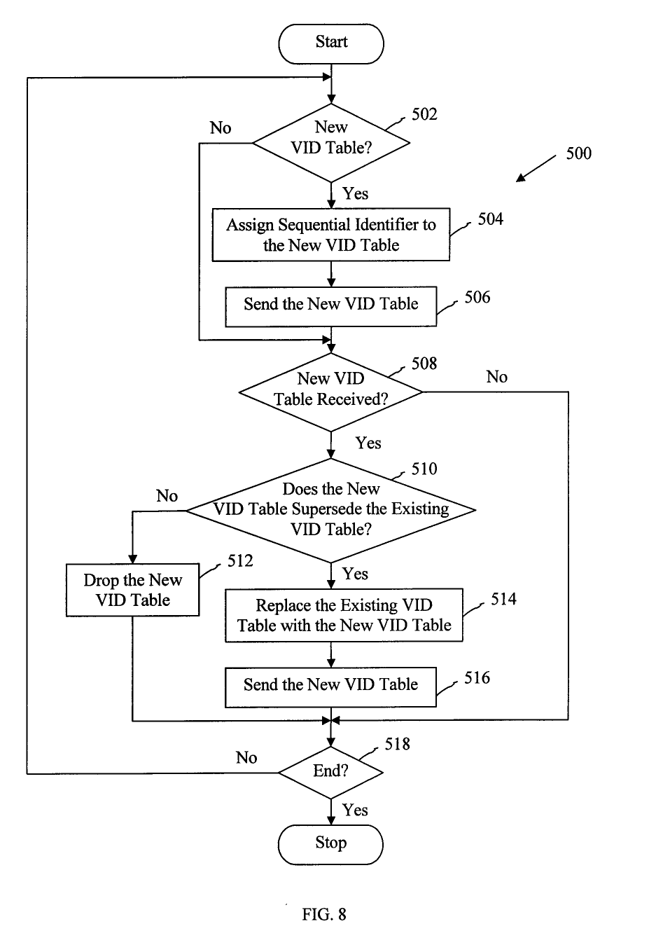

FIG. 8 is a flowchart of another embodiment of the VID Table Consistency Verification Method 500. The VID Table Consistency Verification Method 500 assigns an identifier to each version of the VID Table, and replaces the existing VID Tables when a new version becomes available. Alternatively, the nodes may exchange VID Table versions and keep the latest version of the VID Table. The VID Table Consistency Verification Method 500 can be implemented at a single source, such as a server or a node, may be distributed at the nodes within the network, or may be a combination of centralized and distributed. In a specific embodiment, the VID Table versions may be distributed throughout the network using the spanning tree infrastructure, which eliminates looping within the network. Persons of ordinary skill in the art will be aware of how to modify the VID Table Consistency Verification Method 500 such that it may be implemented or controlled by a management or control plane, if desired.

The VID Table Consistency Verification Method 500 may then determine whether there is a new VID Table at 502. There may be a new VID Table if the node has updated its own VID Table or has had its VID Table updated. If the VID Table Consistency Verification Method 500 determines there is a new VID Table, then the VID Table Consistency Verification Method 500 proceeds to block 504. If the VID Table Consistency Verification Method 500 determines there is not a new VID Table, then the VID Table Consistency Verification Method 500 proceeds to block 508.

The VID Table Consistency Verification Method 500 may then assign an identifier to the new VID Table at 504. Several types of identifiers may be used with the VID Table, including a timestamp, an incremental sequence of numbers such as integers, or any other type of identifier that differentiates one version of a VID Table from other versions of the VID Table. The space within the VID Table for the identifier may be sufficiently large so that problems associated with wrapping of identifier do not occur. The VID Table Consistency Verification Method 500 then proceeds to block 506.

The VID Table Consistency Verification Method 500 may then forward the VID Table at 506. The VID Table Consistency Verification Method 500 may send the VID Table to a centralized server or node, or may forward the VID Table to the adjacent nodes, for example by flooding the VID Table onto all of the node's ports. In an alternative embodiment, the VID Table Consistency Verification Method 500 may flood the VID Table onto less than all of the ports if the VID Table Consistency Verification Method 500 can exclude at least one of the ports for some reason, for example because the new VID Table was received on a particular port. The VID Table Consistency Verification Method 500 then proceeds to block 508.

The VID Table Consistency Verification Method 500 may then determine whether a new VID Table has been received at 508. A new VID Table may have been received if the node has received a new VID Table from another node or a central source, or if the node is instructed to get a new VID Table from another location. If the VID Table Consistency Verification Method 500 determines a new VID Table has been received, then the VID Table Consistency Verification Method 500 proceeds to block 510. If the VID Table Consistency Verification Method 500 determines a new VID Table has not been received, then the VID Table Consistency Verification Method 500 proceeds to block 518.

The VID Table Consistency Verification Method 500 determines whether the new VID Table supersedes the existing VID Table at 510. The VID Table Consistency Verification Method 500 may determine that the new VID Table supersedes the existing VID Table if the identifier in the new VID Table is a later timestamp, a subsequent number, or is otherwise identified as being newer than the existing VID Table. VID Tables with the same timestamp or sequence number are, by definition, not newer than the existing VID Table. If the VID Table Consistency Verification Method 500 determines the new VID Table does not supersede the existing VID Table, then the VID Table Consistency Verification Method 500 proceeds to block 512. If the VID Table Consistency Verification Method 500 determines the new VID Table supersedes the existing VID Table, then the VID Table Consistency Verification Method 500 proceeds to block 514.

The VID Table Consistency Verification Method 500 may drop the VID Table at 512. In one embodiment, when the VID Table Consistency Verification Method 500 drops the VID Table, the VID Table Consistency Verification Method 500 may simply delete the VID Table. Alternatively, the VID Table Consistency Verification Method 500 may keep a log of the history of the different versions of the VID Tables, either at the node or at a central source. The VID Table Consistency Verification Method 500 then proceeds to block 514.

The VID Table Consistency Verification Method 500 may then replace the existing VID Table with the new VID Table at 514. Specifically, the VID Table Consistency Verification Method 500 may overwrite the contents of the existing VID Table with the contents of the new VID Table. Alternatively, the VID Table Consistency Verification Method 500 may overwrite part of the contents of the existing VID Table with a corresponding part of the contents of the new VID Table. The VID Table Consistency Verification Method 500 then proceeds to block 516.

The VID Table Consistency Verification Method 500 may then forward the VID Table at 516. The VID Table Consistency Verification Method 500 may send the VID Table to a centralized server or node, or may forward the VID Table to the adjacent nodes, for example by flooding the VID Table onto all of the node's ports. In an alternative embodiment, the VID Table Consistency Verification Method 500 may flood the VID Table onto less than all of the ports if the VID Table Consistency Verification Method 500 can exclude at least one of the ports for some reason, for example because the new VID Table was received on a particular port. The VID Table Consistency Verification Method 500 then proceeds to block 518.

The VID Table Consistency Verification Method 500 may then determine whether the VID Table Consistency Verification Method 500 should end at 518. The VID Table Consistency Verification Method 500 should end when instructed to do so, for example, when the administrator closes the VID Table Consistency Verification Method 500, or when the node is being taken offline. If the VID Table Consistency Verification Method 500 determines the VID Table Consistency Verification Method 500 should not end, then the VID Table Consistency Verification Method 500 returns to block 502. If the VID Table Consistency Verification Method 500 determines the VID Table Consistency Verification Method 500 should end, then the VID Table Consistency Verification Method 500 ends.

Similar to the VID Table Consistency Verification Method 450, the VID Table Consistency Verification Method 500 may be implemented using a network management system or application, such as the IEEE 802.1ak MRP. For example, a MTRP can be created where nodes may register, join, leave, or deregister from the table registration process. Specifically, a participant in the protocol, such as a node, can register a table by the table name and the table contents. Other participants may join a registered table by specifying the associated table name. The participants may optionally add entries to or delete entries from the registered table. The operation of this protocol is as follows:
Register (Table Name, Table Contents): Reject request if table of this name already exists.
Join (Table Name, Returns: VID Table Contents): Reject request if no table with this table name.
Leave (Table Name): Reject request if no table with this name.
Deregister (Table Name): Reject request if no table of this table name has been registered or if participants are currently registered to this table name.

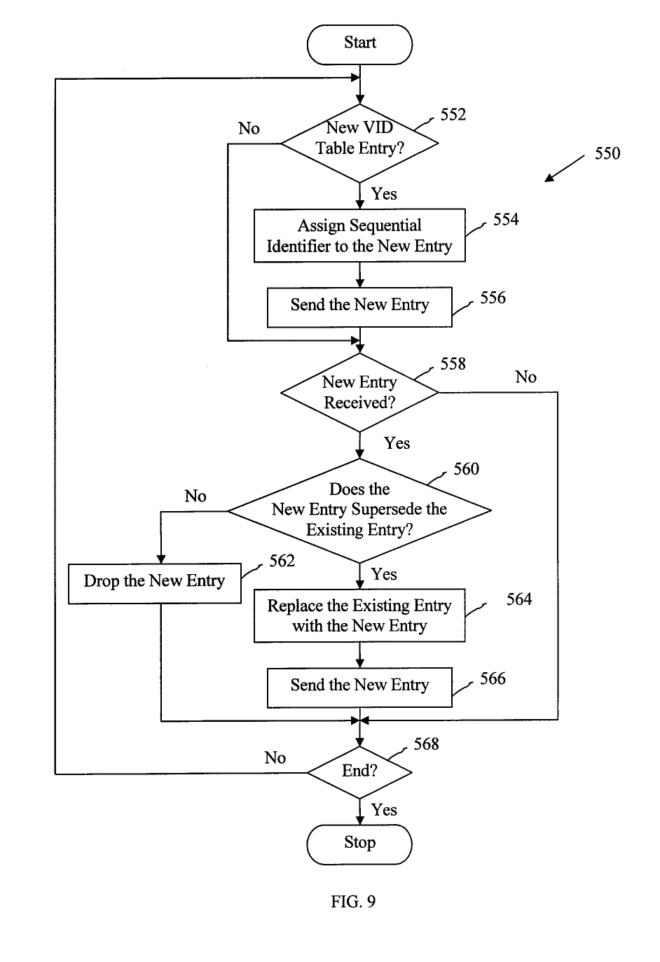

FIG. 9 is a flowchart of another embodiment of the VID Table Consistency Verification Method 550. The VID Table Consistency Verification Method 550 assigns an identifier to each VID Table entry and individually updates each VID Table entry. Alternatively, the nodes may exchange VID Table entries and keep the latest version of each entry. The VID Table Consistency Verification Method 550 can be implemented at a single source, such as a server or a node, may be distributed at the nodes within the network, or may be a combination of centralized and distributed. In a specific embodiment, the VID Table Consistency Verification Method 550 may be similar to the methods used by routing protocols, such as Open Shortest Path First (OSPF) to construct a replicated link state or topology database, but instead to construct a replicated VID Table. Alternatively, the VID Table entries may be distributed throughout the network using the spanning tree infrastructure, which eliminates looping within the network. Persons of ordinary skill in the art will be aware of how to modify the VID Table Consistency Verification Method 550 such that it may be implemented or controlled by a management or control plane, if desired.

The VID Table Consistency Verification Method 550 determines whether there is a new VID Table entry at 552, and if so, assigns an identifier to the new VID Table entry at 554, and sends the new VID Table entry at 556. The VID Table Consistency Verification Method 550 then determines whether a new VID Table entry has been received at 558, and determines whether the new VID Table entry supersedes an existing VID Table entry at 560. If the new VID Table entry supersedes the existing VID Table entry, the existing VID Table entry is replaced with the new VID Table entry at 564; otherwise, the new VID Table entry is dropped at 562. Finally, the VID Table Consistency Verification Method 550 determines whether to end at 568, and either loops back or ends. Each of the blocks of the VID Table Consistency Verification Method 550 is described in further detail below.

The VID Table Consistency Verification Method 550 may then determine whether there is a new VID Table entry at 552. There may be a new VID Table entry if the node has updated an entry in its own VID Table or has had an entry in its VID Table updated. If the VID Table Consistency Verification Method 550 determines there is a new VID Table entry, then the VID Table Consistency Verification Method 550 proceeds to block 554. If the VID Table Consistency Verification Method 550 determines there is not a new VID Table entry, then the VID Table Consistency Verification Method 550 proceeds to block 558.

The VID Table Consistency Verification Method 550 may then assign an identifier to the new VID Table entry at 554. Several types of identifiers may be used with the new VID Table entry, including a timestamp, an incremental sequence of numbers such as integers, or any other type of identifier that differentiates one VID Table entry from another VID Table entry. The VID Table Consistency Verification Method 550 then proceeds to block 556.

The VID Table Consistency Verification Method 550 may then forward the new VID Table entry at 556. The VID Table Consistency Verification Method 550 may send the new VID Table entry to a centralized server or node, or may forward the new VID Table entry to the adjacent nodes, for example by flooding the new VID Table entry onto all of the node's ports. In an alternative embodiment, the VID Table Consistency Verification Method 550 may flood the new VID Table entry onto less than all of the ports if the VID Table Consistency Verification Method 550 can exclude at least one of the ports for some reason, for example because the new VID Table entry was received on a particular port. The VID Table Consistency Verification Method 550 then proceeds to block 558.

The VID Table Consistency Verification Method 550 may then determine whether a new VID Table entry has been received at 558. A new VID Table entry may have been received if the node has received a new VID Table entry from another node or a central source, or if the node is instructed to get a new VID Table from another location. If the VID Table Consistency Verification Method 550 determines a new VID Table entry has been received, then the VID Table Consistency Verification Method 550 proceeds to block 560. If the VID Table Consistency Verification Method 550 determines a new VID Table entry has not been received, then the VID Table Consistency Verification Method 550 proceeds to block 568.

The VID Table Consistency Verification Method 550 determines whether the new VID Table entry supersedes the existing VID Table entry at 560. The VID Table Consistency Verification Method 550 may determine that the new VID Table entry supersedes the existing VID Table entry if the identifier in the new VID Table entry has a later timestamp, a subsequent number, or is otherwise identified as being newer than the existing VID Table entries. VID Table entries with the same timestamp or sequence number are, by definition, not newer than the existing VID Table entry. If the VID Table Consistency Verification Method 550 determines the new VID Table entry does not supersede the existing VID Table entry, then the VID Table Consistency Verification Method 550 proceeds to block 562. If the VID Table Consistency Verification Method 550 determines the new VID Table entry supersedes the existing VID Table entry, then the VID Table Consistency Verification Method 550 proceeds to block 564.

The VID Table Consistency Verification Method 550 may drop the new VID Table entry at 562. In one embodiment, when the VID Table Consistency Verification Method 550 drops the new VID Table entry, the VID Table Consistency Verification Method 550 may simply delete the new VID Table entry. Alternatively, the VID Table Consistency Verification Method 550 may keep a log of the history of the different VID Table entries, either at the node or at a central source. The VID Table Consistency Verification Method 550 then proceeds to block 564.

The VID Table Consistency Verification Method 550 may then replace the existing VID Table entry with the new VID Table entry at 564. Specifically, the VID Table Consistency Verification Method 550 may overwrite the contents of the existing VID Table entry with the contents of the new VID Table entry. Alternatively, the VID Table Consistency Verification Method 550 may overwrite part of the contents of the existing VID Table entry with a corresponding part of the contents of the new VID Table entry. The VID Table Consistency Verification Method 550 then proceeds to block 566.

The VID Table Consistency Verification Method 550 may then forward the new VID Table entry at 566. The VID Table Consistency Verification Method 550 may send the VID Table entry to a centralized server or node, or may forward the new VID Table entry to the adjacent nodes, for example by flooding the new VID Table entry onto all of the node's ports. In an alternative embodiment, the VID Table Consistency Verification Method 550 may flood the new VID Table entry onto less than all of the ports if the VID Table Consistency Verification Method 550 can exclude at least one of the ports for some reason, for example because the new VID Table entry was received on a particular port. The VID Table Consistency Verification Method 550 then proceeds to block 568.

The VID Table Consistency Verification Method 550 may then determine whether the VID Table Consistency Verification Method 550 should end at 568. The VID Table Consistency Verification Method 550 should end when instructed to do so, for example, when the administrator closes the VID Table Consistency Verification Method 550, or when the node is being taken offline. If the VID Table Consistency Verification Method 550 determines the VID Table Consistency Verification Method 550 should not end, then the VID Table Consistency Verification Method 550 returns to block 552. If the VID Table Consistency Verification Method 550 determines the VID Table Consistency Verification Method 550 should end, then the VID Table Consistency Verification Method 550 ends.

Similar to the VID Table Consistency Verification Method 450 and the VID Table Consistency Verification Method 500, the VID Table Consistency Verification Method 550 may be implemented using a network management system or application, such as the IEEE 802.1ak MRP. For example, a MTRP can be created where nodes may register, join, leave, or deregister from the table registration process. Specifically, a participant in the protocol, such as a node, can register a table by the table name and the table contents. Other participants may join a registered table by specifying the associated table name. The participants may optionally add entries to or delete entries from the registered table. The operation of this protocol is as follows:
Register (Table Name, Table Contents): Reject request if table of this name already exists.
Join (Table Name, VID Number, Forwarding Type): The VID number and associated forwarding type are distributed to all devices. Sequence numbers ensure that table versions are consistent in steady state. Reject request if no table with this table name.
Leave (Table Name, VID Number): Clears the VID entry. Reject request if no table with this name.
Deregister: (Table Name): Reject request if no table of this table name has been registered. The protocol can optionally reject if participants are currently registered to this table name.

Persons of ordinary skill in the art will appreciate that the processes described herein can be modified to include the various concepts described herein. For example, it is contemplated that the processes described herein can be modified to create a method for verifying that the distributed VID Tables contain consistent content, or a method for distributing a replicated VID Table, where the entries specify whether the individual VIDs are bridged or switched. Such methods may be useful for distributing the existing version of the VID Table to all nodes in the network and to nodes joining the network, for example by a Simple Network Management Protocol (SNMP) SET function, or distributing individual VID Table entries to the nodes in the network when a node joins the network, or when a VID Table entry changes, is added, or is deleted. Such methods may also be useful for reading the existing version of the VID Table at all nodes in the network and at nodes joining the network, for example using the SNMP GET function, in order to verify that there are no inconsistencies among the VID Tables, or reading individual VID Table entries at all nodes in the network when a node joins the network, or when the entries change, are added, or are deleted in order to verify that there are no inconsistencies among the VID Tables.

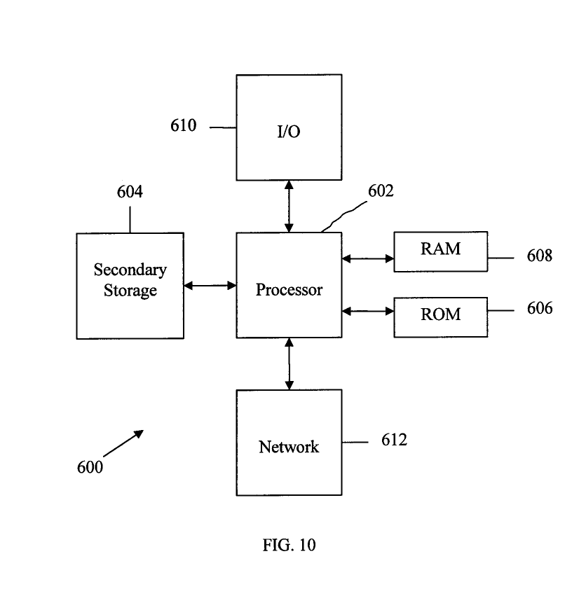

The network described above may be implemented on any general-purpose network component, such as a computer, router, switch, or bridge, with sufficient processing power, memory resources, and network throughput capability to handle the necessary workload placed upon it. FIG. 10 illustrates a typical, general-purpose network component suitable for implementing one or more embodiments of a node disclosed herein. The network component 600 includes a processor 602 (which may be referred to as a central processor unit or CPU) that is in communication with memory devices including secondary storage 604, read only memory (ROM) 606, random access memory (RAM) 608, input/output (I/O) 610 devices, and network connectivity devices 612. The processor may be implemented as one or more CPU chips.

The secondary storage 604 is typically comprised of one or more disk drives or tape drives and is used for non-volatile storage of data and as an over-flow data storage device if RAM 608 is not large enough to hold all working data. Secondary storage 604 may be used to store programs that are loaded into RAM 608 when such programs are selected for execution. The ROM 606 is used to store instructions and perhaps data that are read during program execution. ROM 606 is a non-volatile memory device that typically has a small memory capacity relative to the larger memory capacity of secondary storage. The RAM 608 is used to store volatile data and perhaps to store instructions. Access to both ROM 606 and RAM 608 is typically faster than to secondary storage 604.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1. A communications network component comprising a processor configured to implement a method comprising:
receiving a first data structure comprising a first VID and a first forwarding type;
determining whether the first data structure supersedes a second data structure comprising a second VID and a second forwarding type; and
replacing the second data structure with the first data structure if the first data structure supersedes the second data structure.

2. The component of claim 1 wherein the first VID is the same as the second VID, and wherein the first forwarding type is not the same as the second forwarding type.

3. The component of claim 1 wherein the first VID is not the same as the second VID, and wherein the first forwarding type is the same as the second forwarding type.

4. The component of claim 1 wherein the first data structure and the second data structure are individual entries in a table comprising a plurality of the VIDs and a plurality of the forwarding types associated with the VIDs.

5. The component of claim 1 wherein the first data structure and the second data structure are tables comprising a plurality of the VIDs and a plurality of the forwarding types associated with the VIDs.

6. The component of claim 1 wherein the first data structure comprises a first timestamp and the second data structure comprises a second timestamp, and wherein the first timestamp and the second timestamp are used to determine whether the first data structure supersedes the second data structure.

7. The component of claim 1 wherein the first data structure comprises a first sequential identifier and the second data structure comprises a second sequential identifier, and wherein the first sequential identifier and the second sequential identifier are used to determine whether the first data structure supersedes the second data structure.

8. The component of claim 1 wherein the method further comprises sending the first data structure to a node.

9. The component of claim 1 wherein the method is implemented using a network management system or application.

10. A method for maintaining the consistency of a table in a plurality of nodes, comprising:
receiving a registration of a table comprising a VID and a forwarding type; and
distributing the table to a plurality of nodes associated with the registration.

11. The method of claim 10 further comprising:
receiving a second VID and a second forwarding type from one of the nodes; and
adding the second VID and the second forwarding type to the table.

12. The method of claim 10 further comprising: deleting the VID and the forwarding type from the table based on instructions from one of the nodes.

13. The method of claim 10 wherein the table comprises a plurality of the VIDs and a plurality of the forwarding types, and the method further comprises allowing the nodes to individually associate with less than all of the VIDs and the forwarding types.

14. The method of claim 10 wherein the forwarding type comprises bridged or switched.

15. The method of claim 10 wherein the method is implemented using a network management system or application.

16. A communications network component comprising a processor configured to implement a method comprising:
determining whether a data structure needs to be sent to a node; and
promoting the sending of the data structure to the node if the data structure needs to be sent to the node,
wherein the data structure comprises a plurality of VIDs and a plurality of forwarding types associated with the VIDs.

17. The component of claim 16 wherein determining whether the data structure needs to be sent to the node comprises:
determining whether a second data structure has been received; and
determining that the data structure needs to be sent to the node if the second data structure has been received.

18. The component of claim 17 wherein the method further comprises replacing the contents of the data structure with the contents of the second data structure.

19. The component of claim 16 wherein when a new link has been established with the node, the method further comprises determining whether the data structure needs to be sent to the node.

20. The component of claim 16 wherein the method further comprises:
starting a timer, and
wherein determining whether the data structure needs to be sent to the node comprises:
determining whether the timer has expired; and
determining that the data structure needs to be sent to the node if the timer has expired.

21. An apparatus comprising:
a table comprising a plurality of VIDs and a forwarding type associated with each VID.

22. The apparatus of claim 21, wherein the forwarding type for each VID is selected from the group consisting of: bridged and switched.

23. The apparatus of claim 21, wherein the apparatus further comprises a memory configured to store the table.
